(19) United States
(12) Patent Application Publication
(10) Pub. No.: US 2017/0177031 A1
(43) Pub. Date: Jun. 22, 2017

(54) DRAWER, DRAWER INSERT AND WORKSTATION WITH ELECTRONIC PANEL FOR CHARGING AND SYNCHING

(71) Applicants: Scott LESIZZA, New York, NY (US); John MACK, New York, NY (US)

(72) Inventors: Scott LESIZZA, New York, NY (US); John MACK, New York, NY (US)

(21) Appl. No.: 15/454,336

(22) Filed: Mar. 9, 2017

Related U.S. Application Data
(63) Continuation of application No. 15/179,535, filed on Jun. 10, 2016.
(60) Provisional application No. 62/174,917, filed on Jun. 12, 2015.
(60) Provisional application No. 62/265,039, filed on Dec. 9, 2015.

(51) Int. Cl. G06F 1/16; A47B 88/919; A47B 88/994; H02J 7/02; A47B 88/42; G06F 1/18; H01R 33/92; H01R 24/76; A47B 88/483; A47B 88/90

(52) U.S. Cl. CPC G06F 1/1632; A47B 88/483; A47B 88/919; A47B 88/994; A47B 88/941; A47B 88/42; G06F 1/189; H01R 33/92; H01R 24/76; H02J 7/025; A47B 2220/0091; H01R 2107/00

(57) ABSTRACT

A storage compartment, a workstation, and a drawer including: a mountable drawer case that includes a recessed portion including a low top surface positioned lower than a front portion and rear portion top surfaces; and an electronic panel that includes an electrical outlet and an electronic communication port, such as an HDMI or USB port, to synchronize, backup and/or charge the electronic device. The drawer may also include a trough projecting down from a rear portion and including the electronic panel. The workstation may include a receiving surface oriented horizontally to receive an electronic device; and a vertical storage component to stores items and having a top aperture positioned behind the receiving surface to permit the items to be removed from the vertical storage component; and an electronic panel.

### CROSS-REFERENCE TO RELATED APPLICATIONS

The present application is a continuation under 37 C.F.R. §1.53(b) of prior U.S. patent application Ser. No. 15/179,535, filed Jun. 10, 2016, which in turn claims priority to U.S. Provisional Patent Application No. 62/174,917, filed Jun. 12, 2015 and U.S. Provisional Patent Application No. 62/265,039, filed Dec. 9, 2015, the entire contents of each of these applications are incorporated herein by reference.

### FIELD OF THE INVENTION

The present disclosure relates to the field of drawers, workstations, docking stations, and secure containers for accommodating electronic devices and, in particular, to drawers, drawer inserts, drawer trays included in drawers and workstations that accommodate a portable electronic device and that include an electrical panel for charging, synchronizing or backing up the electronic device, and a vertical storage component.

### BACKGROUND

With the proliferation of handheld devices, mobile telephones, smartphones, electronic notepads, tablets, laptops, notebooks, netbooks, e-readers, electronic personal music players and the like, the organization, security and safety of these devices have become important concerns for many consumers. Many Americans have multiple devices that need to be charged, re-charged, or synchronized at various periods of time or intermittently. These devices take up valuable space in an ever shrinking home or workspace. Often, people wish to charge more than one such device simultaneously.

Drawers and shelves can store, organize, secure and keep safe such devices. However, such devices often need to be charged so as to replenish drained internal or external batteries, and thus need an electric socket, which security drawers often lack. For example, people enter new contact information, photos or other image or the like into their smart phones, add new music to their personal electronic music players, add information, texts, PDFs or other content to their tablets, netbooks receive new e-mails, SMS or text and the like. This data needs to be backed up or synchronized with other devices.

Mobile office environments are intended to facilitate interaction between workers and, often, shrink the amount of available desk space. In these typically more open spaces, an employee may lack a traditional “desktop” computer and a desk with pedestal and drawers. Synchronizing or backing up devices is important, too, since people while at work or at a workstation may enter new information, in their laptops, computers, or other electronic devices, and this information may need to be shared in real time with coworkers or others and backed up so as to be available on another device if the person moves from the space and so as not to be lost in case of damage to the device.

### SUMMARY OF THE DISCLOSURE

It is an object of the present invention to provide a drawer, a drawer system, a workstation and a workstation system are described. The drawer includes:
a drawer case that may be mounted under a surface, and including a top cover that has:
a forward portion including: a first top surface, and a first wall positioned at a rear portion of the forward portion and projecting down from the top surface;
a rear portion including: a second top surface, and a second wall positioned at a front of the rear portion and projecting down from the second top surface; and
a recessed portion including a third top surface positioned lower than the first and second top surfaces, the third top surface positioned adjacent the first and second walls;
a drawer insert positioned insider the drawer case to be slidable with respect to the drawer case so as to open and to close the drawer; and
an electronic panel positioned at a rear portion of the drawer and including an electrical outlet and an electronic communication port.

Such a drawer may also include a trough positioned projecting down from a bottom surface of the rear portion of the drawer case, and the trough including the electronic panel.

This drawer may further include: a flap positioned inside the drawer and configured to cover the electronic panel at least one of when the drawer is open and when the drawer is closed, the flap configured to be openable so as to reveal the electronic panel.

Also, the drawer may include: a transition portion positioned immediately in front of the electronic panel, the drawer case including a bottom surface with holes positioned underneath the transition portion.

A flap may be positioned inside the drawer and configured to cover the electronic panel and the transition portion, the flap arranged to be openable so as to reveal the electronic panel and the transition portion.

In such a drawer, the electronic panel may be positioned in the drawer or in the drawer outside the drawer insert.

The electronic panel may include a USB port.

The drawer insert may include a bottom, and the drawer may further include:
a tray comprising a tray bottom,
wherein the tray and the drawer insert are configured such that the tray, when received in the drawer insert, is positioned such that the tray bottom leaves a substantial gap above the bottom of the drawer insert.

The tray may include a pair of lips that are arranged to be mounted on lateral side mounting portions of the drawer insert.

The tray may include a wireless inductive charger positioned at a bottom of the tray.

The drawer insert may also include a wireless inductive charger positioned at a bottom of the drawer insert.

The workstation for an electronic device is also described. The workstation may include:
a receiving station component that includes:
a workstation front, and
a receiving surface oriented horizontally and configured to receive the electronic device, the receiving surface positioned behind the workstation front;
a vertical storage component configured to store at least one item, the vertical storage component having a top aperture positioned behind the receiving surface and configured to permit the at least one item to be moved into and to be removed from the vertical storage component; and
an electronic panel that includes an electronic port configured at least one of to synchronize, to backup and to charge the electronic device.

In such a workstation, the electronic panel may include an electric power outlet, a digital data port that enables electronic synchronization of the electronic device, a USB port, an HDMI port, and/or an apple-compatible port different from a USB port and from an HDMI port.

The receiving station may include: a bottom wall comprising the receiving surface as a top surface, and the bottom of the receiving station may be inclined down in a distal direction from the workstation front.

The receiving surface may include a plurality of air holes configured to allow air to pass through to outside of the workstation under the receiving station component.

The receiving surface may include a wireless inductive charger positioned at a bottom of the drawer insert.

The workstation may include a slide mechanism positioned on a lateral surface of the workstation and configured to slide the workstation with respect to a desk or other surface to which the workstation is mounted. Also, the receiving station may include side walls positioned adjacent the slide mechanism.

Other features and advantages of the present invention will become apparent from the following description of the invention which refers to the accompanying drawings.

### BRIEF DESCRIPTION OF THE FIGURES

For the purposes of illustrating the invention, the Drawings illustrate embodiments that are presently preferred, it being understood, however, that the invention is not limited to the precise arrangements and instrumentalities shown. The features and advantages of the present invention will become apparent from the following description of the invention that refers to the accompanying Drawings, in which:

FIG. 1 is a perspective view of an example of an exterior view of a drawer case, according to an aspect of the disclosure.

FIG. 2 is a perspective view of an example of an interior of the drawer, according to an aspect of the present disclosure.

FIG. 3 is a top view of an example of the drawer, according to according to an aspect of the present disclosure.

FIG. 4 is a bottom view of an example of the drawer, according to an aspect of the present disclosure.

FIG. 5 is a top view of an example of an interior of the drawer with a tray and electronic devices, according to an aspect of the present disclosure.

FIG. 6 is a top view of an example of an interior of the drawer with the tray and with a laptop beneath the tray, according to an aspect of the present disclosure.

FIG. 7 is a top view of an example of an interior of the drawer with a laptop computer inside, according to an aspect of the present disclosure.

FIG. 8 is a top view of an example of an interior of the drawer in an empty state, according to an aspect of the present disclosure.

FIG. 9A is a front view of an example of the drawer, according to an aspect of the present disclosure.

FIG. 9B is a perspective view of an example of the drawer case and the drawer insert in the open position with the drawer tray removed, according to an aspect of the present disclosure.

FIGS. 10A and 10B are side views, right and left, respectively, illustrating, by way of example, dimensions of the drawer, according to an aspect of the present disclosure.

FIGS. 11A-11D are views illustrating, by way of example, views of the drawer, including the front (11A) and back (11D).

FIG. 12 illustrates, by way of example, a top view of the drawer, according to an aspect of the present disclosure.

FIG. 13 illustrates, by way of example, a bottom view of the drawer, according to an aspect of the present disclosure.

FIG. 14A illustrates, by way of example, a right side view of the drawer, according to an aspect of the present disclosure.

FIG. 14B is a right side cross section view of an example of the drawer showing a flap, in a semi-open position, that covers the electronic panel according to an aspect of the present disclosure.

FIGS. 15A and 15B illustrate, respectively, an example of front and back views of the drawer insert, according to an aspect of the present disclosure.

FIGS. 16A-16C, 17A-17C, 18A-18C, 19 and 22 provide various views of an example of the drawer insert, according to an aspect of the present disclosure.

FIGS. 20A-20D and 21A-21C illustrate an example of the insert tray with wire guard, according to an aspect of the present disclosure.

FIG. 23A is a perspective view of an example of a workstation including a receiving station component and a vertical storage component, according to an aspect of the present disclosure.

FIG. 23B is another perspective view of the example of the workstation, according to an aspect of the present disclosure.

FIG. 24A is a side view of the example of the workstation, according to an aspect of the present disclosure.

FIG. 24B is a top view of the example of the workstation, according to an aspect of the present disclosure.

FIG. 25 is a perspective view illustration of a detail of the receiving station component of the workstation highlighting the receiving surface and drawer pull of the workstation, according to an aspect of the present disclosure.

FIG. 26A is a top view of the example of the workstation, according to an aspect of the present disclosure.

FIG. 26B is a front view of the example of the workstation, according to an aspect of the present disclosure.

FIG. 26C is a perspective view of the example of the workstation, according to an aspect of the present disclosure.

FIG. 26D is a left side view of the example of the workstation, according to an aspect of the present disclosure.

FIG. 27A is an illustration providing a perspective view with transparent sides of an example of a second embodiment of a workstation, according to an aspect of the present disclosure.

FIG. 27B is another perspective view, of the second embodiment of the workstation, according to an aspect of the present disclosure.

FIG. 28A is another perspective view of the example of the second embodiment of the workstation, according to an aspect of the present disclosure.

FIG. 28B is a top view of the example of the second embodiment of the present disclosure.

FIGS. 29A-29D are top, perspective, front and side, respectively, views of the example of the second embodiment of the workstation, with opaque side walls, according to an aspect of the present disclosure.

FIG. 30 illustrates the rear wall of the workstation with a fan encased in the rear wall, according to an aspect of the present disclosure.

### DETAILED DESCRIPTION OF THE EMBODIMENTS

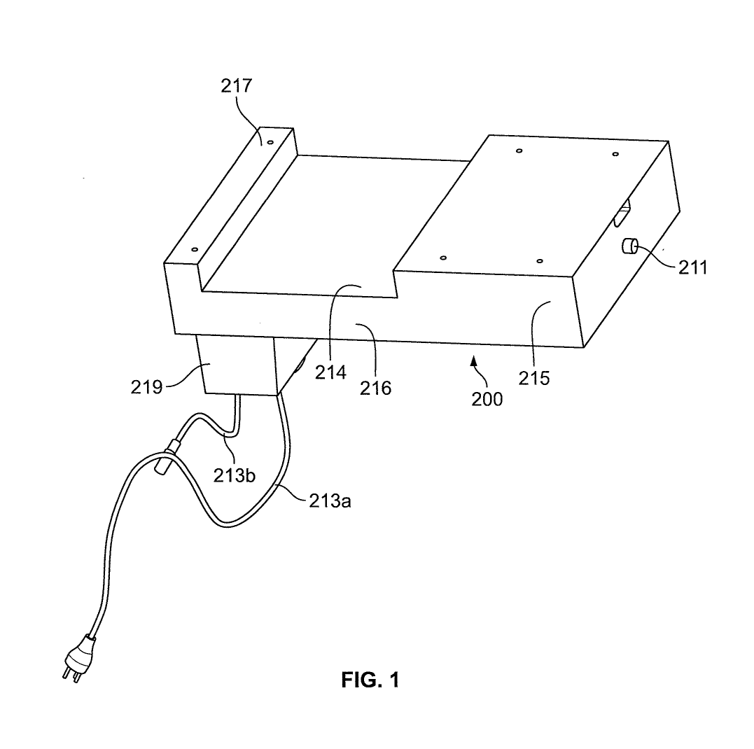

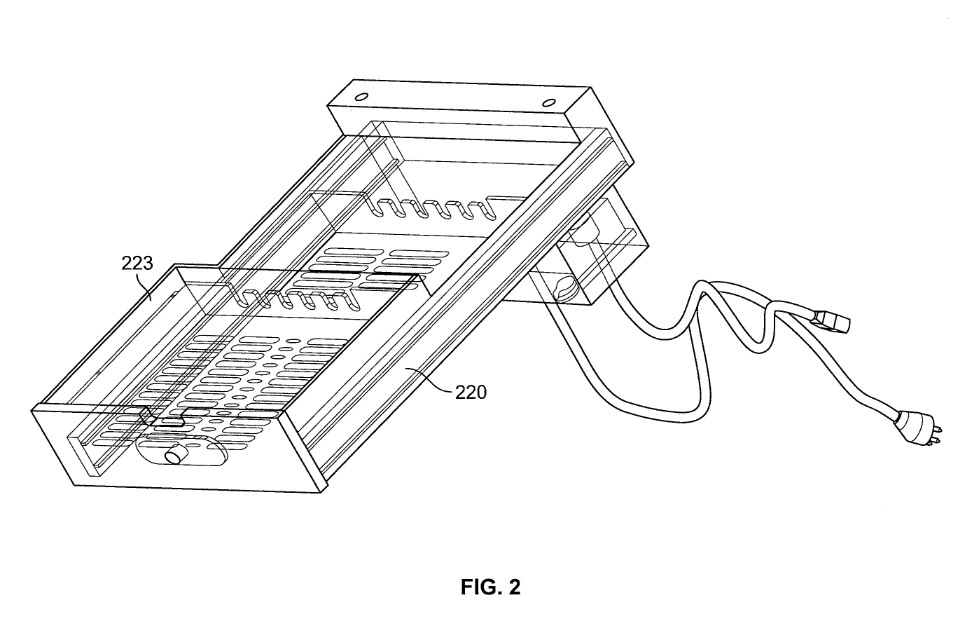

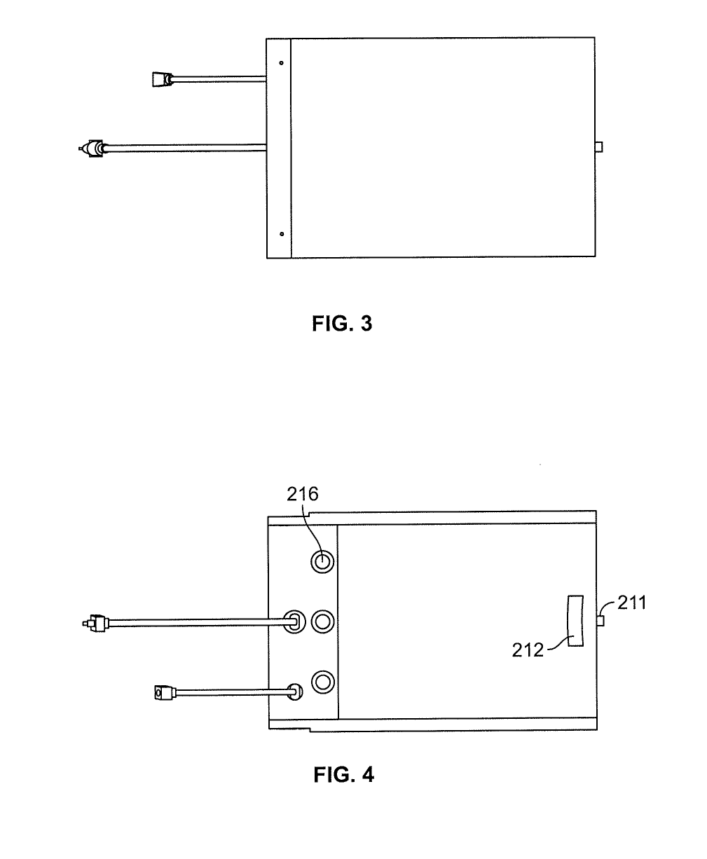

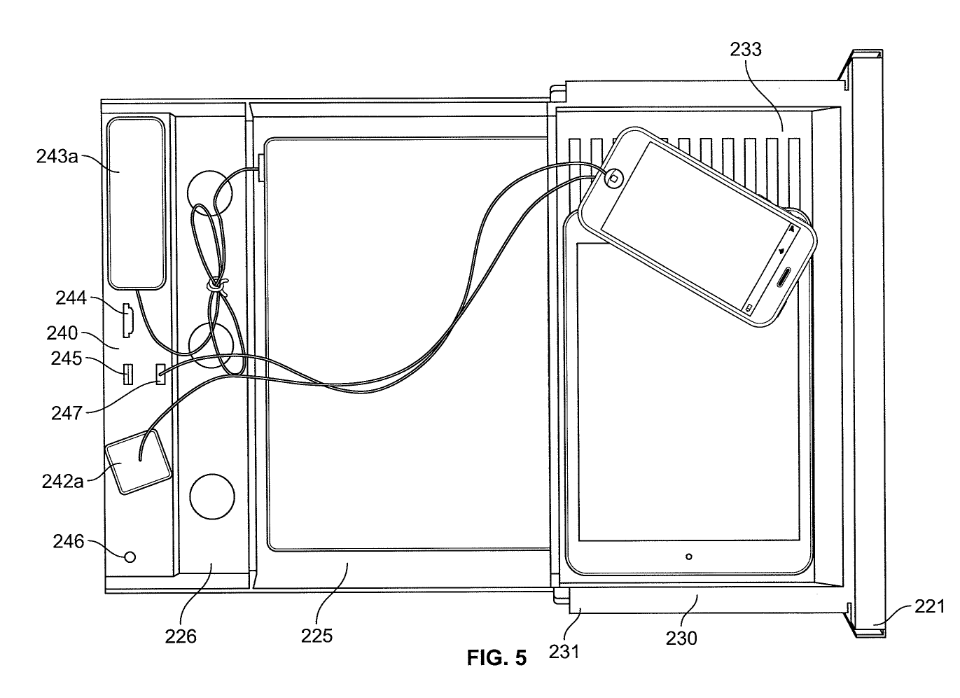

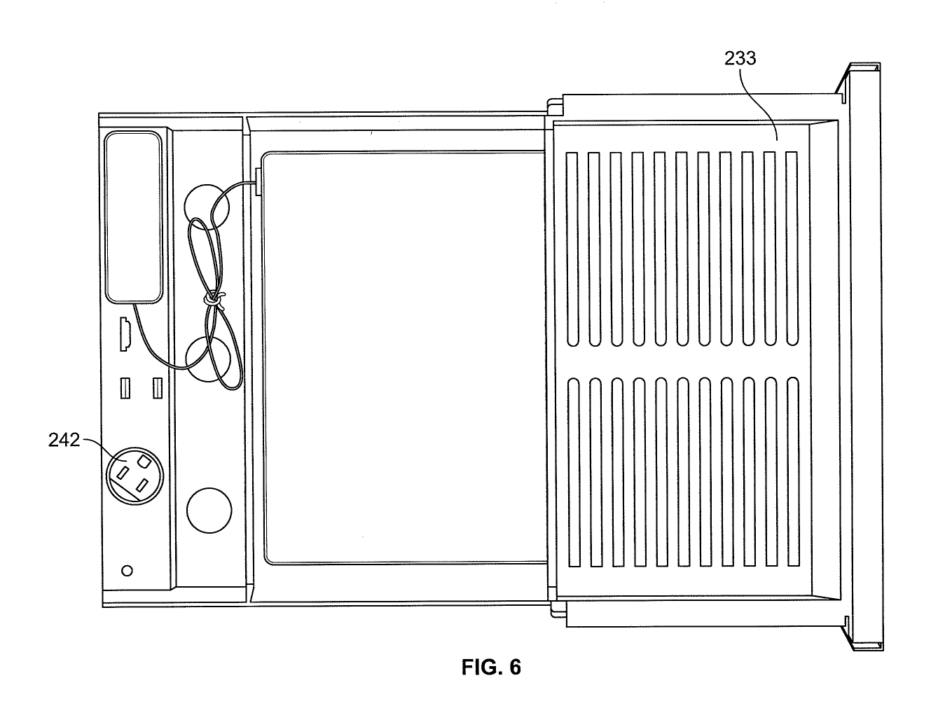

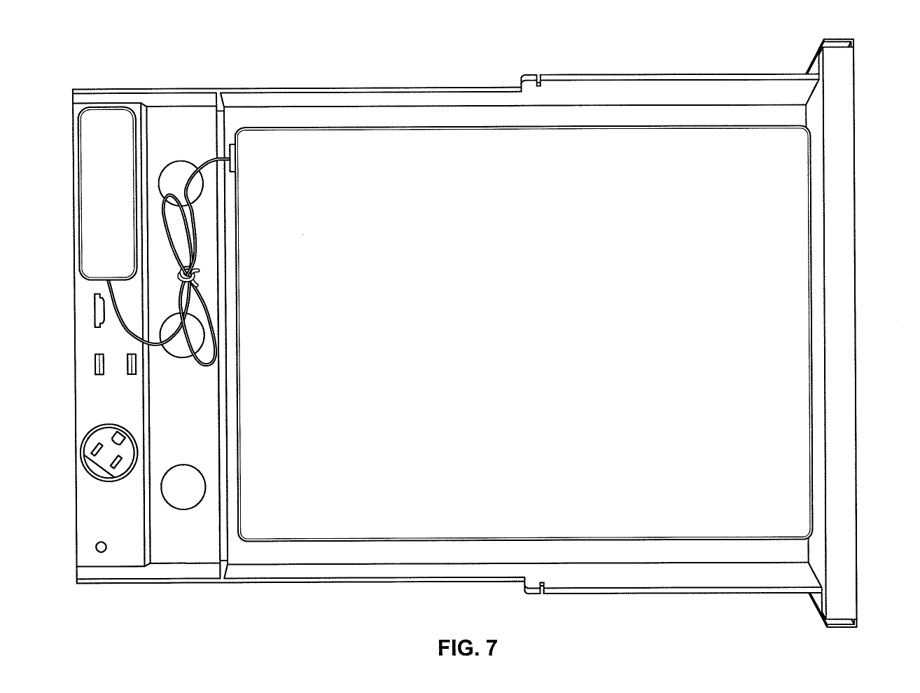

FIG. 1 illustrates an exterior view of a drawer case 200, which may be positioned under a desk surface, table, cabinet or other kind of surface or the like. FIG. 2 illustrates the drawer interior. As also shown in FIGS. 1 and 2, a cutout portion 214 at the top of drawer case 200 accommodates a support bar or beam or the like that is a common support structure feature of desks and tables and that lies under the desk, table or other surface under which drawer case 200 is mounted. Drawer insert 220 can extend underneath this cutout portion 214 and provide space for storage, for example, of the laptop as illustrated in FIGS. 5 and 6. As illustrated in FIGS. 1 and 2, drawer case 200 may also include a downward bulge 219 that serves as a storage compartment that accommodates electronic panel 240 illustrated in FIG. 5. Thus, better utilization of the space under the desk may be obtained because the drawer case can conform more closely to the available space. At the same time, the profile of the drawer case and drawer may be minimized in the space occupied typically by the user's knees and thighs.

FIG. 1 illustrates electronic cable 213a, which is an electrical cord with a plug that may be plugged into an electronic socket (not illustrated), and 213b which may be a cord with a USB plug or other type of cord, such as a USB-C, HDMI cable, or the like. It will be understood that electronic panel 240 may also include other types of ports and connectors including headphone outlet or jack, speaker output or jack, coaxial cable (cable TV) output or jack, microphone output or jack, and the like, and ports for proprietary technologies, such as ports for Apple's devices, such as Lighting connector, Firewire and the like. Electronic panel 240 of bulge 219 may include a surge protector, AC/DC converter, step down/step up adapter and the like.

FIG. 1 illustrates a front portion 215 of the drawer, and a reduced height portion 216 that has cutout portion 214 for accommodating an under desk surface bar, beam or other support structure. As illustrated in FIG. 1, front portion 215 of drawer case 200 may also include a lock 211, which may be open by a key or may be a combination lock.

FIG. 5 illustrates a tray 230 that may be positioned inside the drawer.

Tray 230 may be removable from drawer insert 220. Tray 230 may include lips 231 that are positioned over lateral mounts at the top, or at other locations, of the lateral walls of drawer insert 220. It will be understood, however, tray 230 may be integrated with insert 220, and may be slideable but not removable from the lip of the drawer insert. Also, tray 230 may be tiltable about hinges (not illustrated) for example, just as flap 251. In this way, tray 230 may accommodate one or more electronic devices, such as cell phones, smart phones, PDAs, iPADs, iPODs, tablets and/or other handheld devices, which may be charged and/or backed up or synchronized by being plugged into one or more ports of electronic panel 240. As illustrated in FIG. 5, the drawer may also include large space 225 that accommodates a larger electronic device or computer, such as a laptop, notebook, netbook, tablet or other type of machine or apparatus that can be safely stored therein and that may be plugged in to be recharged and to be downloaded, backed up or synchronized while being stored. In this way, a “double decker” configuration may be provided to achieve better utilization of the drawer and a neater appearance.

For example, FIG. 5 illustrates that electronic adapter 243a of the notebook computer shown in FIG. 5 is plugged into plug 243 for charging however, electronic panel 240 also includes USB ports 245 and HDMI input 244 which can also be utilized by electronic devices stored in the drawer. Electronic panel 240 may also include an LED or other type of power indicator 246. Power indicator 256 may indicate that the electrical outlet 242 of electronic panel 240 is operational and/or may indicate that both electrical outlets 242 and 243 of electronic panel 240 are operational. Also, power indicator 256 may indicate that one or more devices is plugged into an electrical outlet, and/or that one or more additional ports, such as USB or HDMI ports of electrical panel 240 have a device that is connected. For example, power indicator 246 may light up as one color, for example green, to indicate that the electrical outlets and/or ports are operational, and may light up, for example red, to indicate that an electrical device is connected thereto. USB port or other types of ports may also be connected via cord 213b or by other cords to a computer such as a desktop or laptop or the like, modem, external hard drive, printer or other peripheral in order to synchronize and/or back up and upload or download data from the electronic devices stored in the drawer. In this way, using HDMI port 244 or USB port 245, using other ports, such as USB-C port or other types of ports, an electrical device can provide an input signal to a monitor connected to the electronic panel or to a computer, and can stream video or audio or the like or can provide other data or information. Similarly, an electronic device connected via such ports can receive information, can play music or the like provided from a device connected to electronic panel 240 or from the Internet connected to a device, for example, a modem or a router, connected to electronic panel 240. Such functionality may also be provided by electronic panel 41 described with reference to workstation 20.

As illustrated in FIG. 5, the use of tray 230 allows better utilization of the limited space of the drawer so that both a larger device, such as a laptop or notebook computer, and smaller handheld electronic devices may be accommodated and charged/synched therein. That is, as illustrated in FIG. 1, drawer case 200 is designed to fit under a desk surface to accommodate a bar, beam or other support structure at cutout 214 of the drawer. Nevertheless, drawer insert 220 accommodates two or more electronic devices stored therein and, at the same time, allows charging and backing up of electronic devices in a safe and neat way. To this end, tray 230 may be positioned inside drawer insert 220 such that the bottom of tray 230 is above the bottom of drawer insert 220 to leave a significant gap. This significant gap, which may be ¾″ or more, or 1.5″ or more, may leave room for a laptop or other device resting on drawer insert 220. For example, drawer insert 220 may be configured and positioned such that the height of the gap is approximately the same, or at least the same, as the height of the drawer insert 220 below the cutout portion 214. In this way, the storage room provided by middle portion 216 of drawer case 200 illustrated in FIG. 1 is not wasted, in that a contiguous storage height is provided by drawer insert 220 under cutout portion 214 and under tray 230.

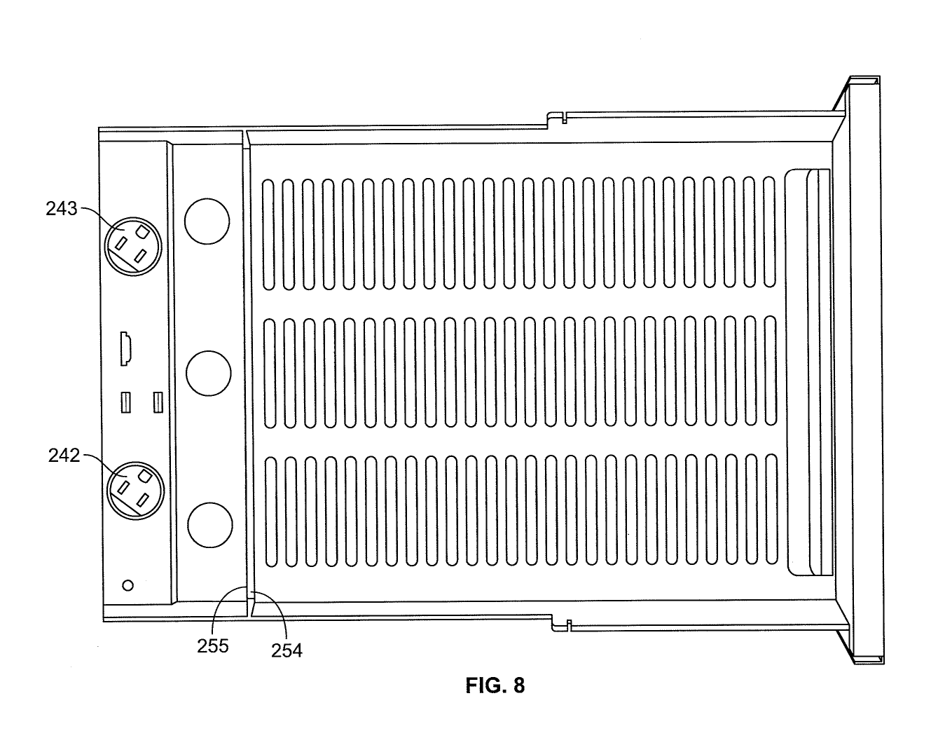

As illustrated in FIG. 8, electronic outlet 243 may be rotatable so that insertion of the prongs may be possible only when the outlet is first rotated for example, rotated 45°, 60° or 90° to its intended position. In this way, the drawer may be kept safe, including from children. Tray 230 may also include mat 233, which may be rubber, plastic or other non-slip, possibly somewhat elastic material, so that electronic devices stored thereon do not slide and are not scraped or scratched as easily. Drawer insert 220 may also include such a mat so as to prevent sliding and scratching or scraping of the electronic device stored thereon and may be somewhat elastic so as to cushion the electronic device and thus to absorb shock. Also, insert 233 may have slots or recesses at the bottom so as to improve airflow and thus cooling of electronic devices stored therein. This may improve fire safety of the electronic devices and the drawer.

Transition portion 226 of the drawer may include one or more holes (three holes are illustrated) which provide venting and cooling air flow to the electronic devices stored in the drawer and may also be used for connecting, charging, synching or backing up additional plugs or cords for electronic devices stored in the drawer.

In addition, tray 230, for example, on a bottom surface of tray 230, may include a wireless electronic charger that can charge or recharge electronic devices stored thereon without the need to connect to them via a cord or plug to an electronic outlet or USB port or the like. The wireless charging pad, may, for example, be compatible with Qi or other inductive-enabled smart charging technology, and may be flat. Such a wireless charger or charging surface may be provided on drawer insert 220, for example, on a bottom or drawer insert 220, in addition to, or instead of on tray 230.

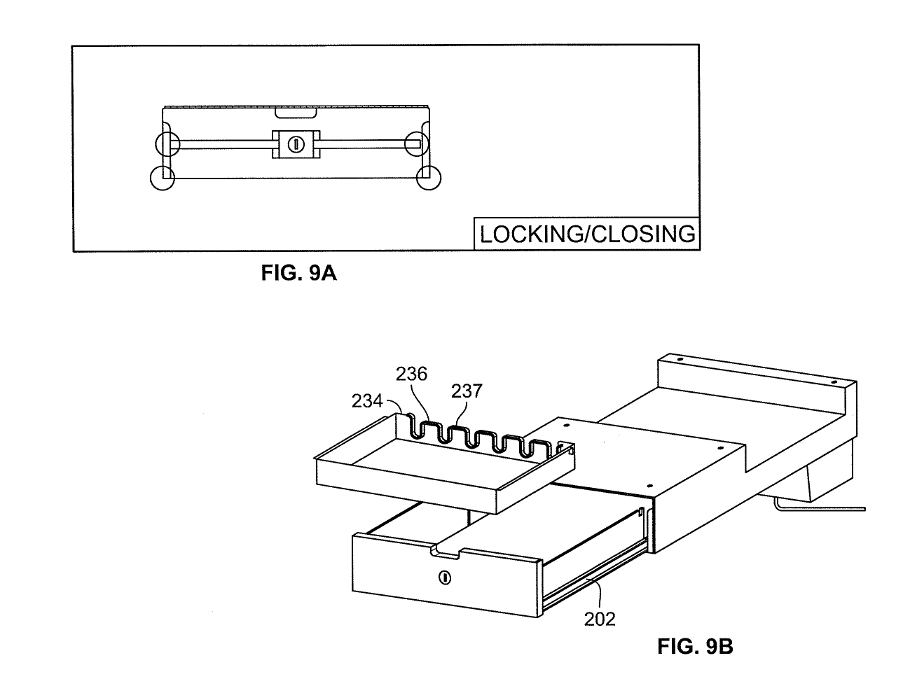

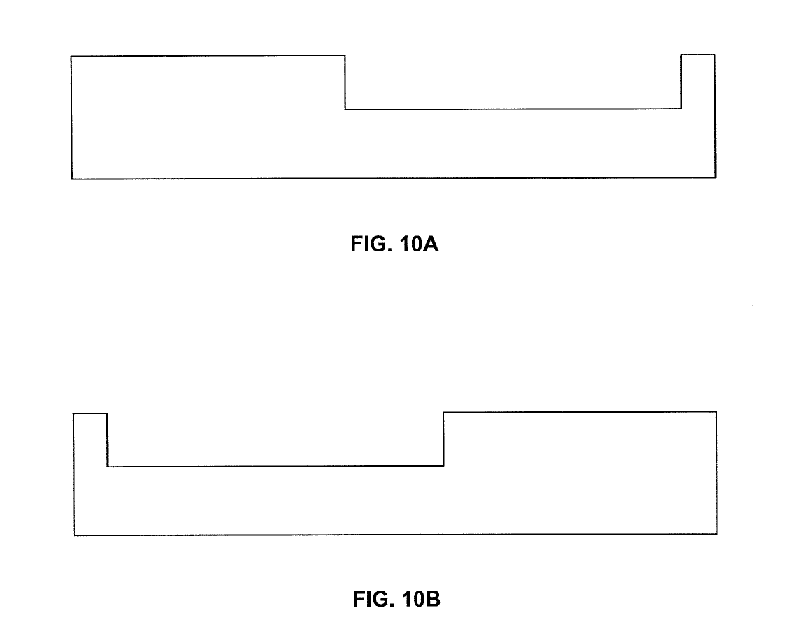

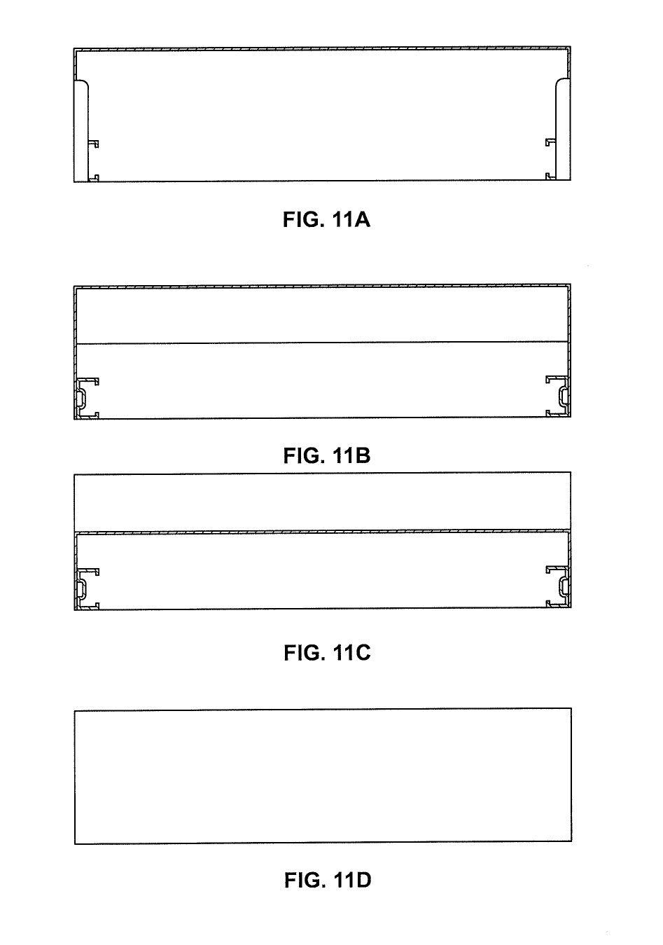

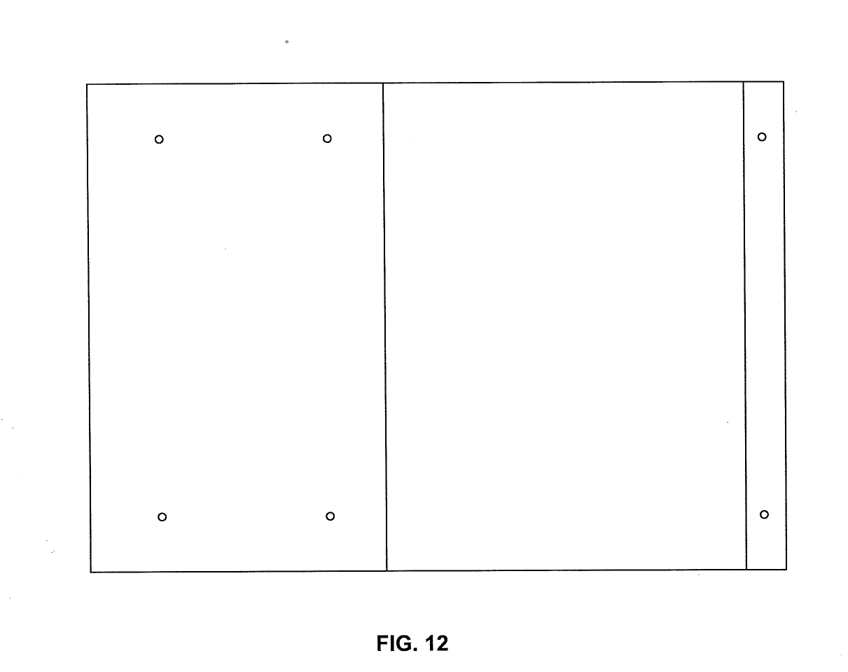

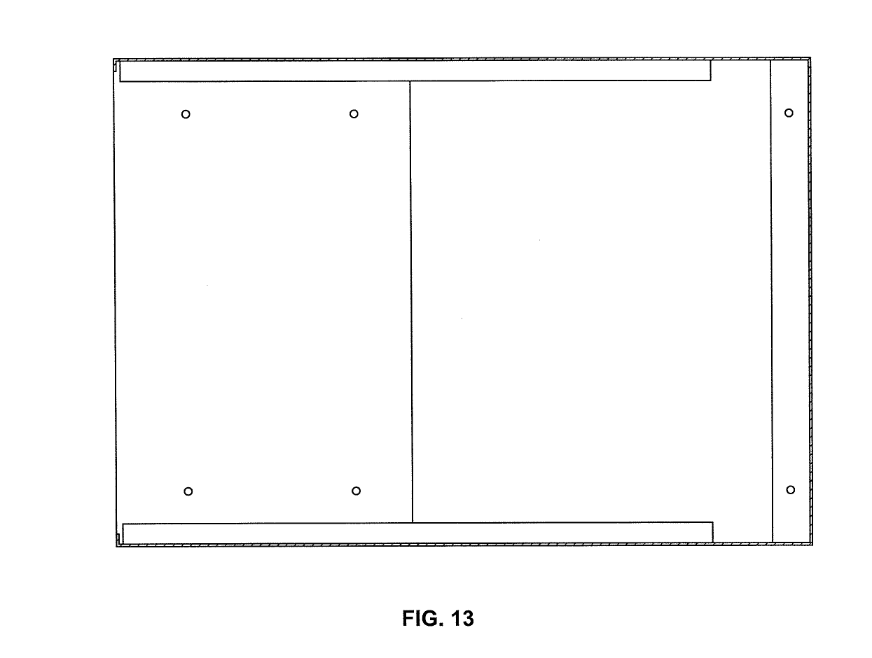

FIG. 9B illustrates that the back end 234 of tray 230 may have cutouts 236 to accommodate rubber wire guard 237. In this way, power cords and cables led from electronic devices may be more neatly and safely led to electronic panel 240. Rubber wire guard 237 may protect such cables and cords from being scraped and from undue moving around as the drawer is opened and closed and thus may provide a neater, more organized, appearance. Each electronic device's plug, cord or cable may be positioned in a separate groove of cutout portion 236.

FIG. 9B also illustrates that drawer insert 220, which is positioned inside drawer case 200, has guide rails 202 which cooperate with drawer case 200 to guide opening and closing of the drawer. Various dimensions are noted for the drawer and the drawer insert throughout the figures. It will be noted, however, that such dimensions provided in this figure and in other figures of the Drawings are noted only by way of one illustrative example but do not limit the scope of the invention.

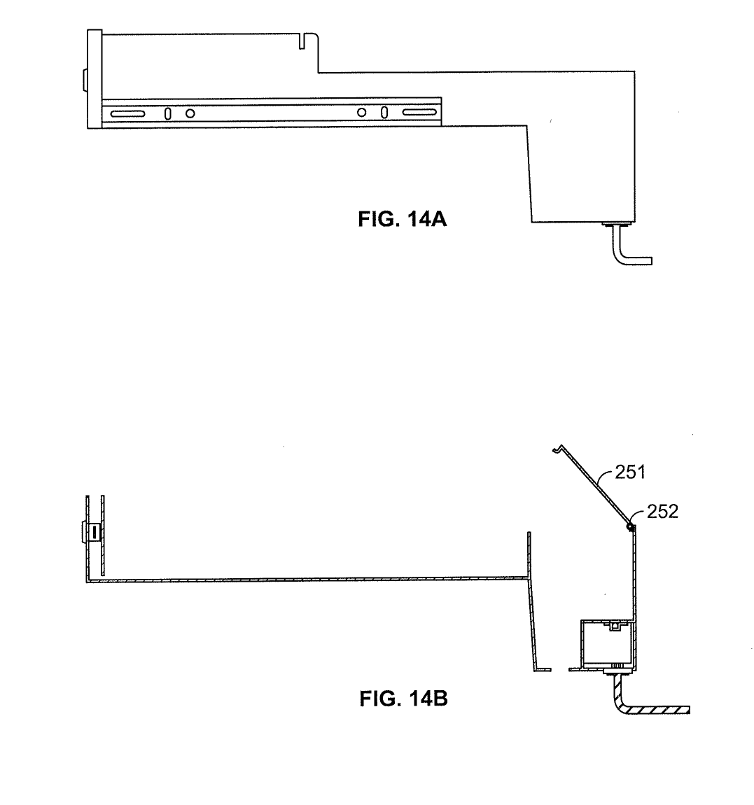

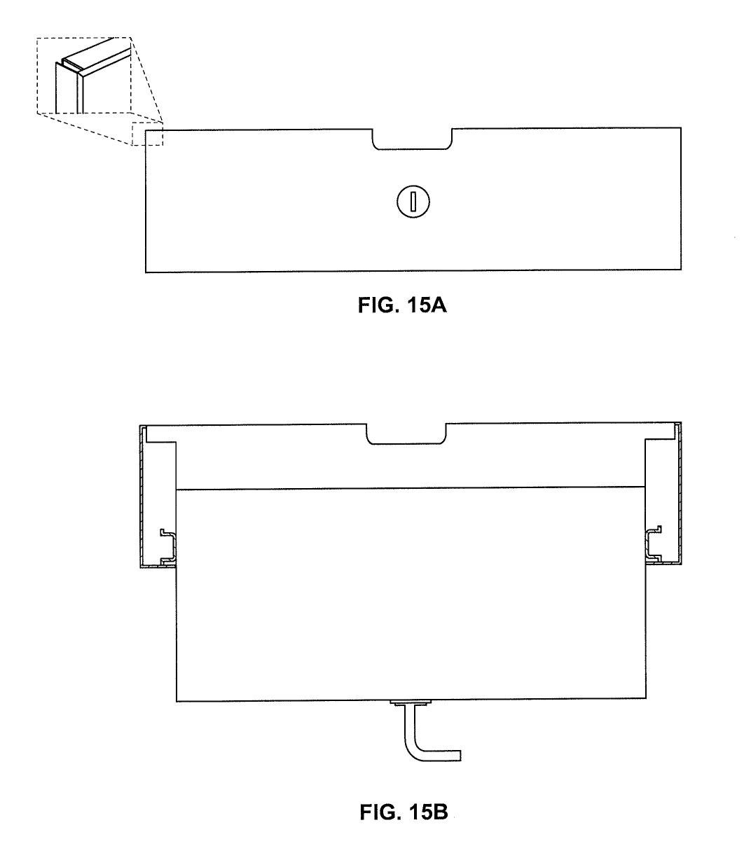

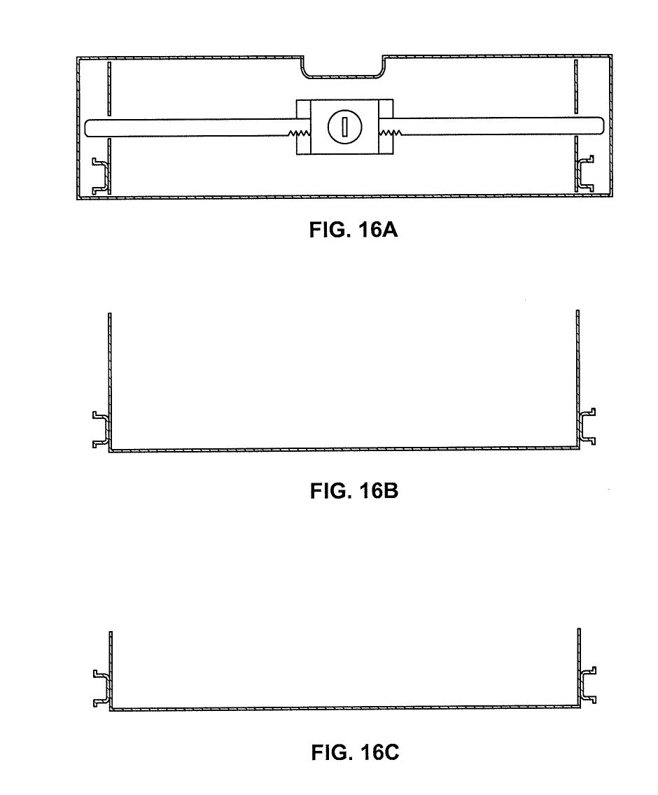

FIG. 14B illustrates flap 251 which may cover transition portion 226 from the top. In this way, the power brick or adapter of laptop (or other kind of electronic device being charged) may be positioned therein. This may reduce the risk of sliding or banging the adapter or power brick of the electronic device being charged and provides for a neater, better organized appearance both when the power brick or adapter is present and when electronic panel 240 is not in use. Flap 251 may be lifted up by rotating it about hinge 252 to remove the adapter/power brick of the electronic device. Flap 251 may cover both the transition portion 226 and the electronic panel 240. FIG. 18B illustrates flap 251 before it is attached via hinge 252 to the drawer insert 220. Flap 251 may be removable by the user or may be integrally formed with drawer insert 220.

FIG. 8 also illustrates cutouts 255 in rear wall 254 of drawer insert 220. Cutout 255 may also include a rubber wire guard to protect the cable or cord of the electronic device stored in the drawer from fraying or being scraped or damaged and to prevent undue movement of electronic devices stored in the drawer when the drawer is opened or closed.

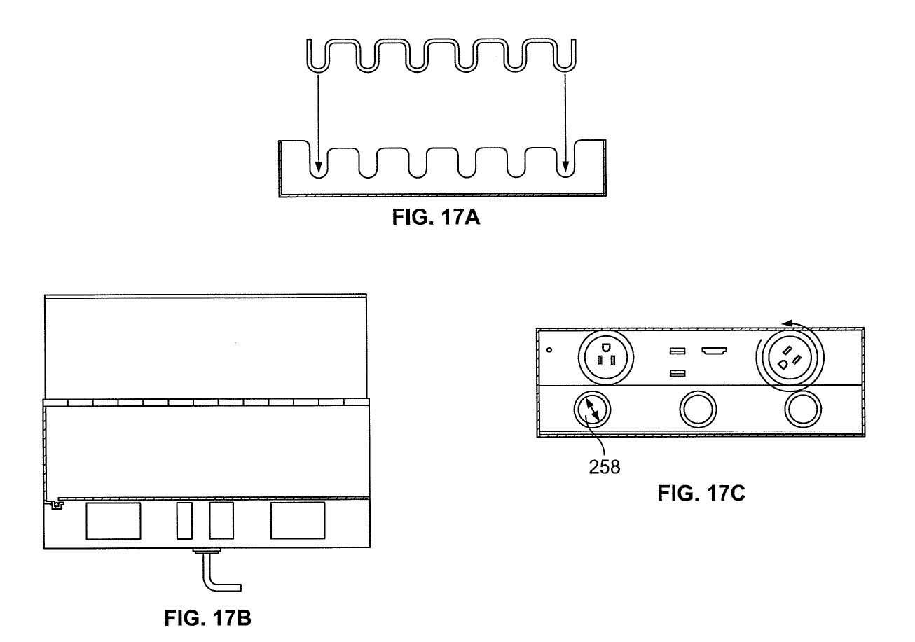

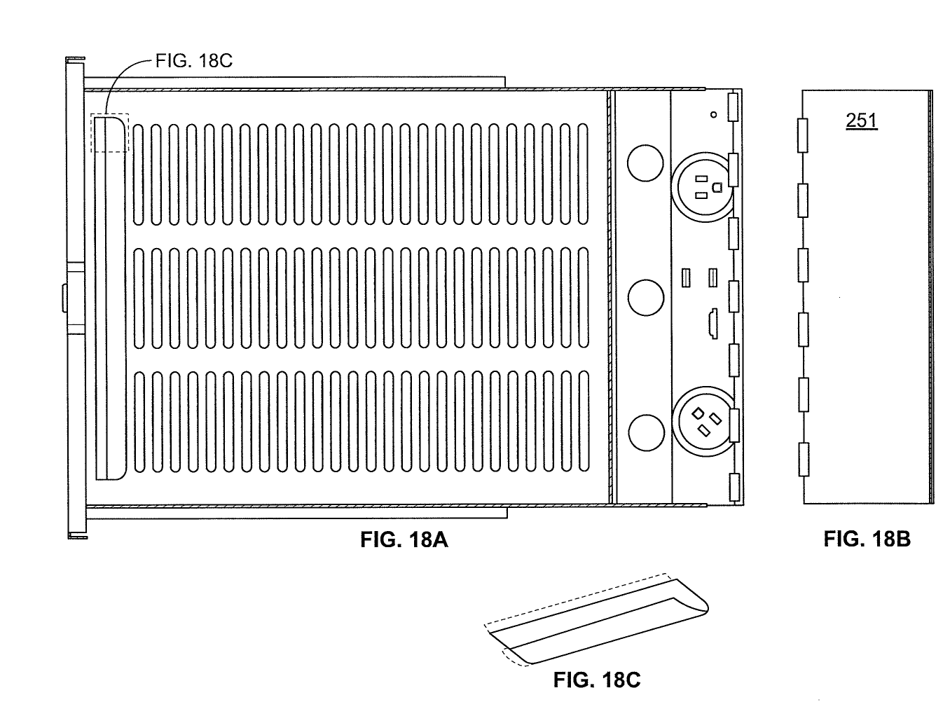

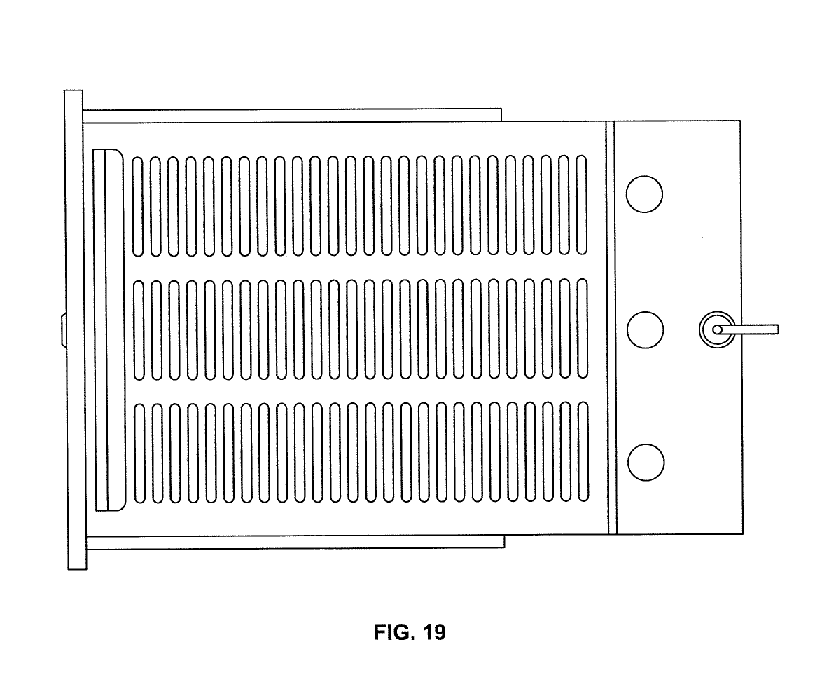

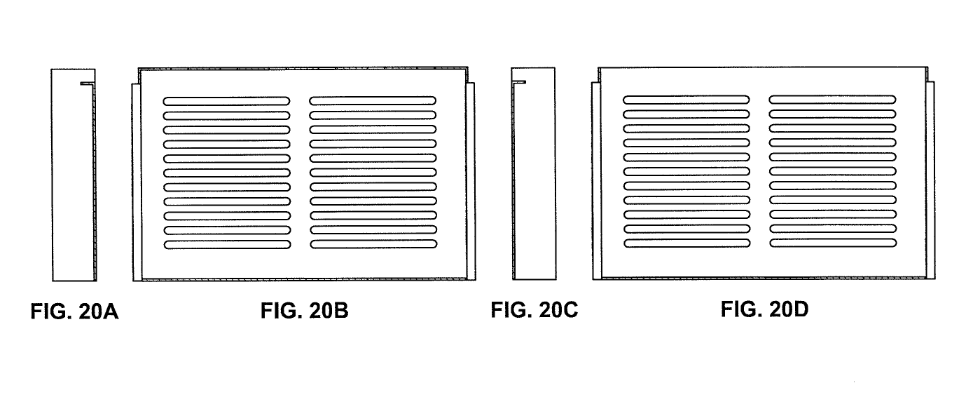

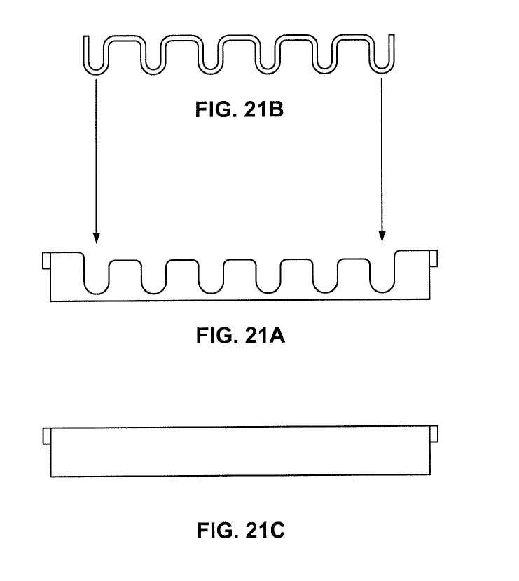

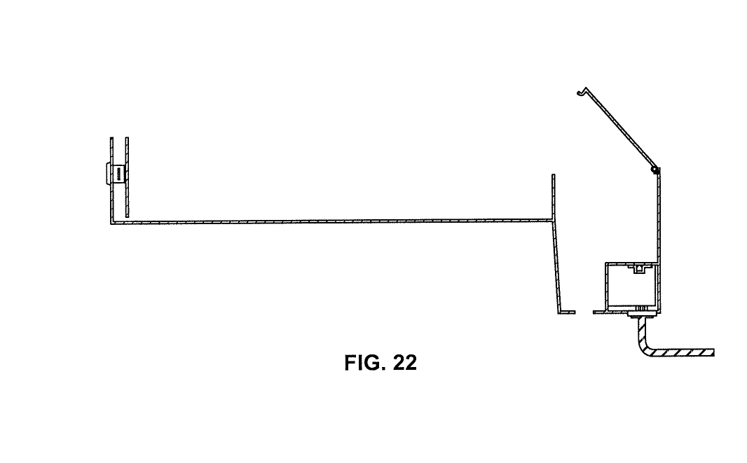

FIG. 17c illustrates gasket 258 in the holes near the bottom of transitional portion. Gaskets or rubber wire guards may be made of rubber, plastic or other types of material.

Transition portion 326 and electronic panel 240 may both be positioned inside downward protruding portion or bulge 219 of drawer case 200. Electronic panel may also include a rectifier or an electronic power converter, including an adjustable power converter that converts voltage to a target voltage required by one or more of the electronic devices or appliances stored in the drawer or the drawer insert or tray. For example, standard 110 or 220 volt power supply may be converted by electronic panel 240 to a much lower voltage required by a portable or handheld electronic device. It will be understood that electronic panel may also be positioned at other portions of the drawer insert 220 or may be positioned in drawer case 200 in front of the cutout 214. Bulge 219 may also store smaller electronic or other items with the electronic components, including surge protectors, adapters, converters and/or cords, out of the way and largely out of sight. Thus, a more streamlined appearance for the drawer and drawer case may be obtained. Also, valuable real estate near the knees of a user of a desk need not be sacrificed any more than necessary to achieve the desired functionality.

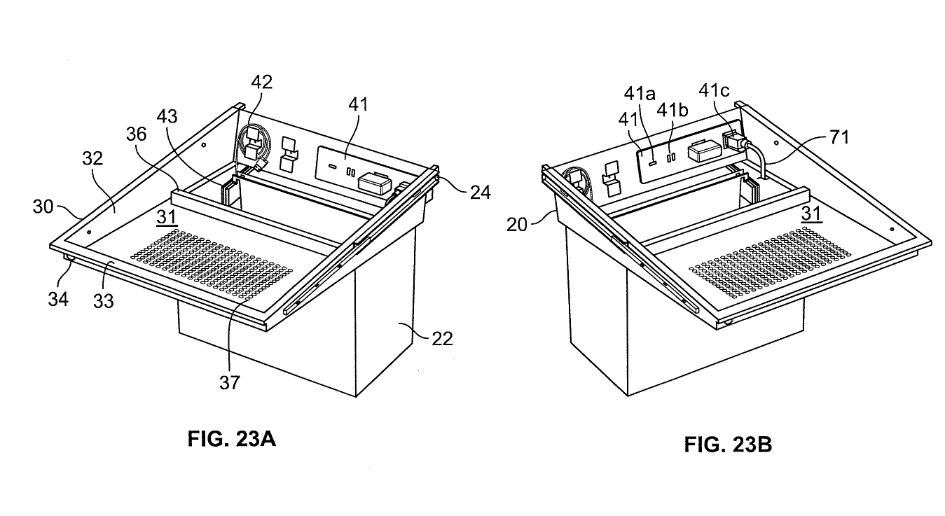

FIGS. 23A and 23B illustrate an example of a workstation that includes the receiving station component 30, which may be oriented horizontally or substantially horizontally, and vertical storage component 22 provided near a back of the workstation distal to the receiving station access component 30. The receiving station component 30 may include receiving surface 31 shown in FIG. 23A or 23B configured and sized to receive an electronic device of the user, for example a laptop computer, netbook or notebook computer or the like, a tablet, a pad, smartphone, PDA or other mobile, handheld or portable electronic device. Workstation 20 may also include drawer slide mechanism 24 so as to allow workstation 20 to be pulled open to reveal its contents and to be closed. For example, workstation 20 may be mounted under a desk or other flat surface and may conveniently house all of an employee's personal effects and/or files and/or electronic devices that the user regularly or frequently needs for work.

As illustrated in FIG. 23B, workstation 20 also includes electronic panel 41, which may include one or more electrical outlets 41c for accommodating a plug of an electronic device 71, an HDMI, USB, USB-C, and/or other cable port, headphone outlet and/or jack, speaker output and/or jack, coaxial cable (cable TV) output and/or jack, microphone output and/or jack, and the like, and ports for proprietary technologies, such as ports for Apple devices, including Lightening connector and/or Firewire port and the like. One or more of such ports, outlets and jacks may also be included in electronic panel 240 described with respect to drawer insert 220. Electronic panel 41 may also include an AC/DC converter, a step down/step up adapter, and/or a power surge protector, and the like. Behind, below or near electronic panel 41, may be provided wires and cables (not shown) for connecting the electrical outlets to an electrical grid and connecting the ports to a local network such as a LAN (Local Area Network), a desktop computer or other device, modem or the like.

In this way, using such ports an electrical device can provide an input signal to a monitor connected to the electronic panel, can stream video and/or audio data and/or the like, can receive command from a keyboard, mouse, track pad, joysticks or the like, located, for example, on the desktop adjacent the workstation and otherwise interact with, control and/or be controlled by, communicate with and/or be communicated to/from a local area network, a modem, a desktop computer and/or other desk-borne device and the like.

FIG. 23A also illustrates cord manager 42, which may be used to wrap an excess length of cord or a cord currently not in use. FIG. 23A illustrates two such cord managers 42, however it will be understood that more or fewer than two cord managers 42 may be provided.

Receiving station component 30 includes receiving surface 31 for accommodating the user's electronic device, and may include air holes 37. Air holes 37 may allow air to pass through the bottom of workstation 20 so as to allow more effective cooling of an electronic device places on top of receiving station 31.

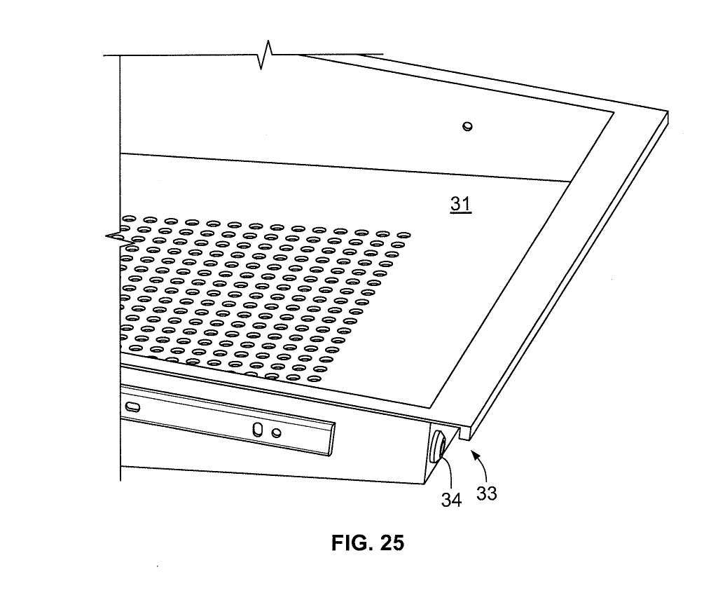

Side walls 32 may also be provided, as well as lip 36 to prevent the electronic device from slipping and falling. As illustrated in FIG. 25, drawer pull 33 may be included to facilitate a user's initiation of the sliding movement along slide mechanism 24 of workstation 20. Thus, when workstation 20 is mounted to or underneath a desk or the like, workstation may be opened by pulling drawer pull 33 to an open position to provide access to the workstation and its contents, and then be closed. Workstation 20 may also provide storage, including longer term storage and security for contents thereof. As illustrated in FIG. 25, workstation 20 may include lock 34 that receives a key of the user to open or permit sliding open of workstation 20. Lock 34 may also provide a combination, electronic or other type of access.

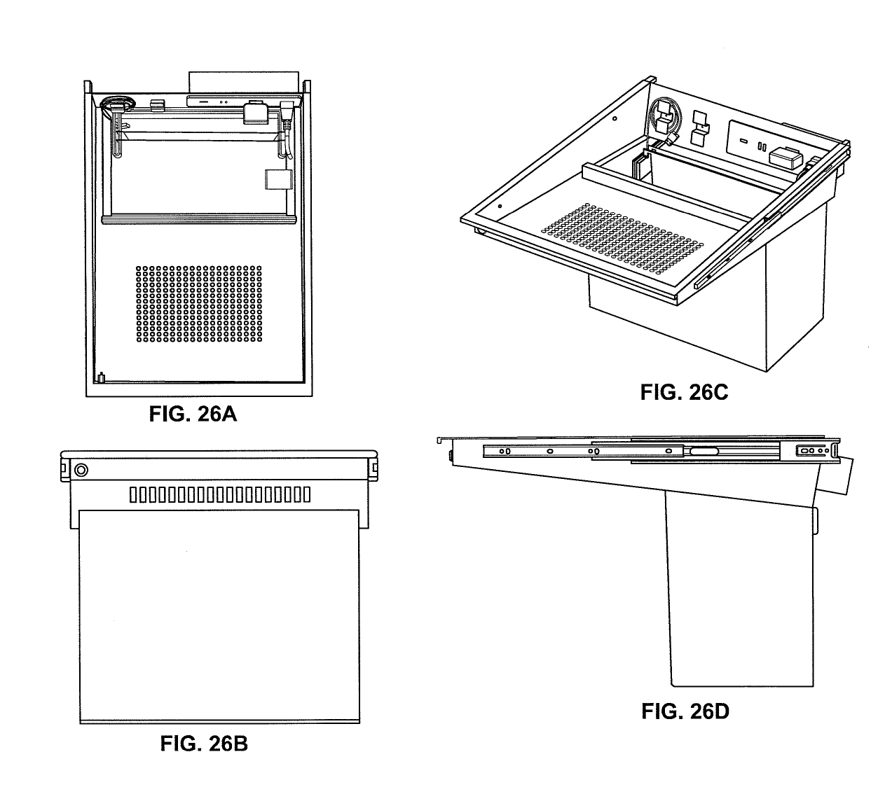

Receiving surface 31 may be inclined down (sloping downward toward the back), as illustrated FIGS. 23A, 23B, 24A, 26C and 26D so that an area of receiving surface 31 that is more remote from the front of workstation 20 may be located further down (closer to the floor). In this way, workstation 20 may provide more storage space in areas more distal to the lap of the user, so as to maximize storage space available but still allow a comfortable fit above the thighs and knees of the user when the user is sitting in front of workstation 20. In this way, leg clearance may be maximized while other storage units such as a desk pedestal(s) may be eliminated.

Such an inclined surface may also achieve a more lean, “neat” or streamlined appearance from the front. Also, if the user is using a keyboard, keypad, mouse, joystick, track pad and/or other user input device of the electronic device positioned on receiving surface 31, more ergonomic positioning for the electronic device and the user input unit may be obtained. That is, the user's wrists and hands may align for a more “natural” and healthy posture when using the user input device positioned on receiving surface 31.

Receiving surface 31 may be parallel or nearly parallel to the floor or to a surface under which workstation 20 is mounted. Also, receiving station 30 may include a bottom wall underneath receiving surface that is inclined down.

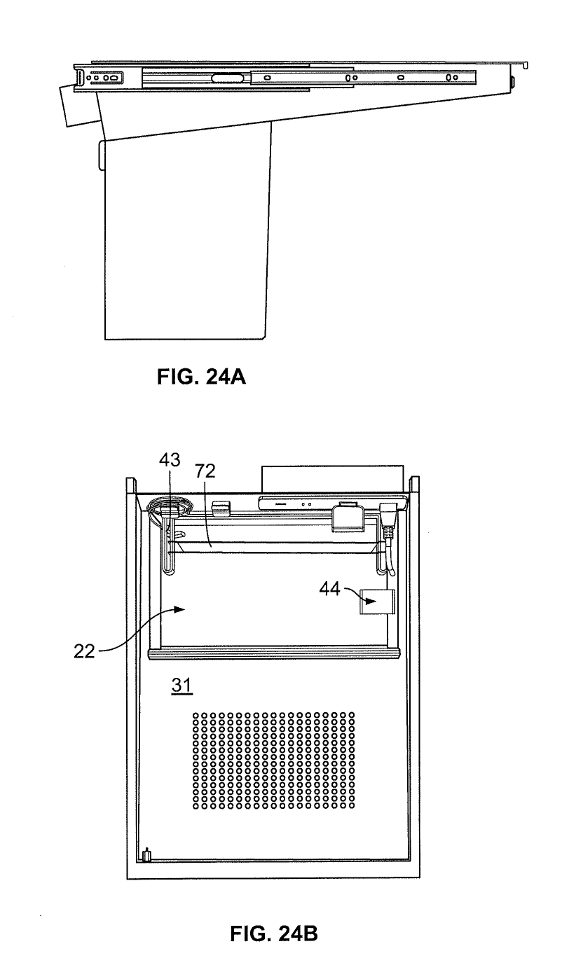

As illustrated in FIG. 24B, workstation 20 includes vertical storage component 22 and an aperture positioned remote from user behind receiving surface 31 allows access to the vertical storage component 22.

As illustrated in FIGS. 23A-23B, vertical storage component 22 may have a footprint significantly smaller than the footprint of receiving station component 30. That is, the front facing wall of vertical storage component 22 may be positioned significantly more distal to the user than the front of receiving station component 30. In addition, the lateral walls of vertical storage component 22 may also be offset from the lateral or sidewalls of receiving station component 30 and drawer slide 24. Accordingly, a more compact and more streamlined design can be achieved for vertical storage component 22. At the same time, receiving surface 31 may be sized to provide a more generous work area to accommodate the electronic device of the user and to provide additional working space for additional items, such as further smaller electronic devices, such as smartphones, headphone, or the like, as well as writing implements and so forth.

FIG. 30 illustrates a fan, which may be encased, or made integral with, the rear wall of the workstation illustrated in FIGS. 23-26, or in, or with, any of the other workstations or drawers described herein. The fan may be connected to a power source via electrical panel or via other means. The fan may provide cooling for handheld devices, laptop computers, or other user devices positioned inside the drawer or workstation. The fan may be positioned elsewhere in the workstation or drawer than in the position illustrated.

Vertical storage component 22 may include one or more hangers 43 to hang hanging folders 72. Files may be stored in such hanging folders 72. Also, as illustrated in FIG. 24B, a brace, bracket or spacer 44 may be included to allow storage of a laptop or other electronic device (not illustrated) to be stored in a vertical orientation inside vertical storage component 22. That is, a vertical spacer 73 may be configured and sized to allow a user to store a laptop or other larger electronic device in a vertical orientation inside vertical storage component 22. In this way, spacer 44 may hold the laptop or electronic device in place, even when the workstation 20 is slid open/closed to reveal or to hide its contents. Spacer 44 may be mounted using a magnet backing or using other types of mounting systems to allow the user to position spacer 44 as dictated by the thickness of the laptop or other electronic device stored therein. For example, spacer 44 may include screws that allow it to be screwed into the sides of the vertical storage or may include an adhesive. Also, more than one such spacer 44 may be included. For example, two spacers may be included, one on each side of the vertical storage component 22. If a U-shaped spacer configuration is used, the same type of spacer 44 may be used for hanging folders and for storing electronic or other items in a vertical position.

However, vertical storage component 22 may be configured and sized differently from the examples illustrated, and may store other types of items. For example, several compartments or spaces may be provided therein to accommodate additional electronic devices, and components and accessories for electronic devices, such as hard drives, flash drives, headphones, earphones, microphones and the like. Such electronic devices and components may also be charged/recharged and synchronized, backed up, control or be controlled by, electronic devices, computers, accessories or the LAN connected to the electronic panel 41 or may communicate therewith by Bluetooth, by Wi-Fi, via cellular communication network, or using other means.

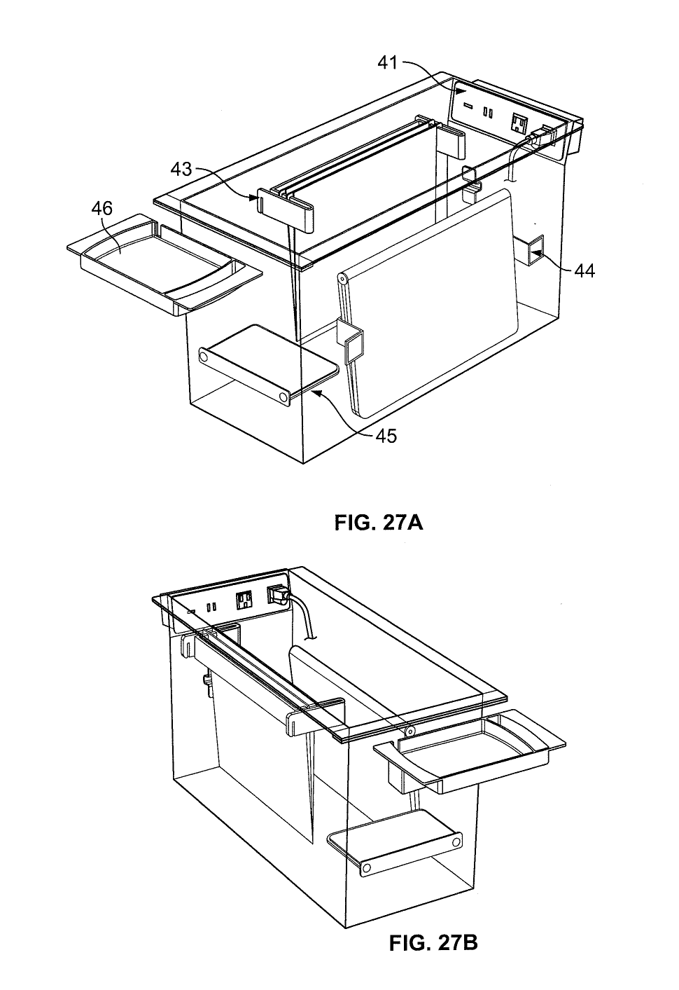

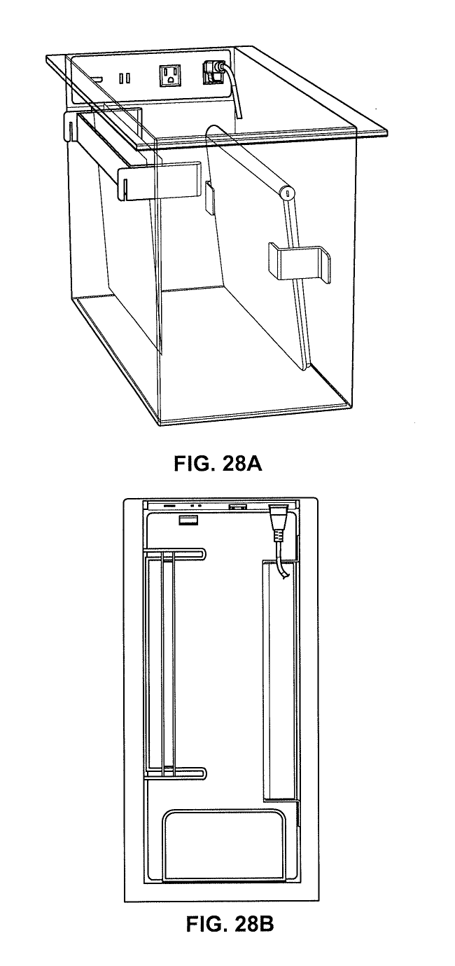

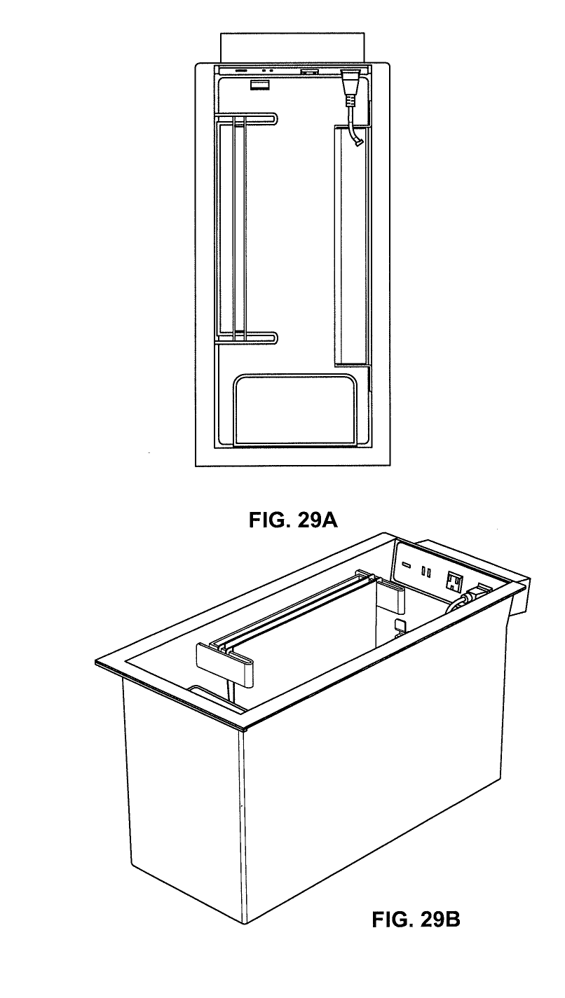

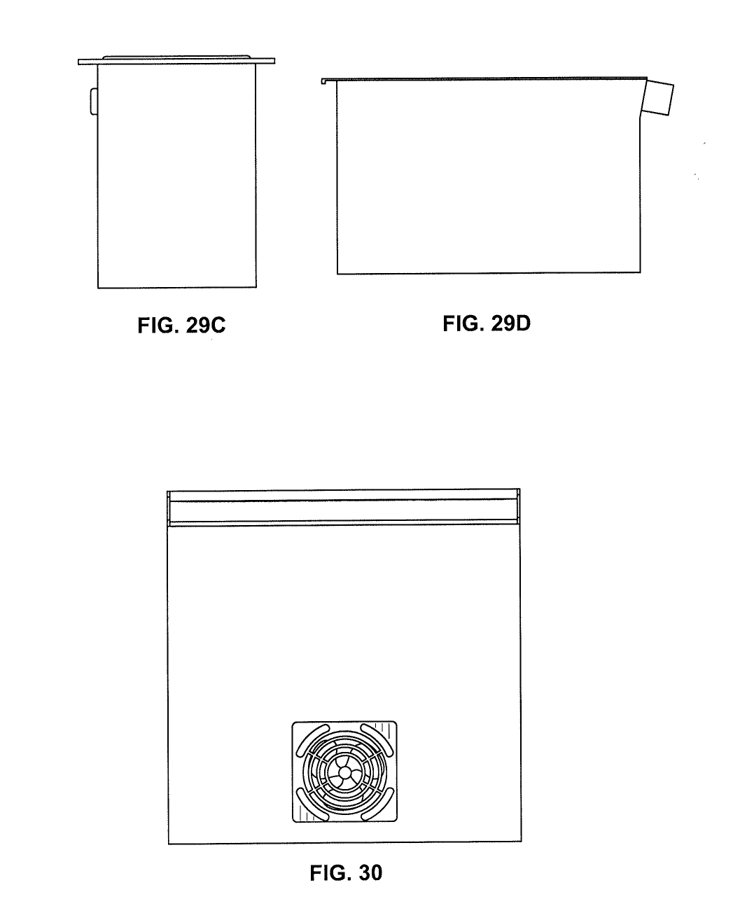

According to a further embodiment illustrated in FIGS. 27A-29D, a storage compartment with electronic panel 41 may be mounted to be slidably retractable under a desk or other surface. A mounting component (not illustrated) may attach to the desk or surface and the storage compartment may attach thereto. A drawer slide mechanism 24 may be mounted to allow the storage compartment to be opened to allow access to its contents, and to be closed by pushing it under the desk or other surface. Storage compartment may also include one or more hanging file holder or hanger 43 and a vertical spacer 73 may also be positioned inside (as illustrated) to hold a laptop or other device in place when stored. A utility shelf or compartment may also be provided, and this may be positionable or removable by the user as needed. One or more cord managers 42 may also be included inside or near the storage compartment.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A storage compartment configured to be retractably mounted under a surface, the storage compartment comprising:
first and second side walls, a real wall, a bottom wall, and a front wall;
a first drawer slide mechanism mounting the first side wall, and a second drawer slide mechanism mounting the second side wall, the storage compartment retractably slidable on the first and second drawer slide mechanisms; and
an electronic panel mounted on the storage compartment and comprising an electrical outlet.

2. The storage compartment of claim 1, wherein the electrical panel comprises a data port.

3. The storage compartment of claim 1, wherein the electrical panel comprises an HDMI port.

4. The storage compartment of claim 1, wherein the electrical panel comprises a USB port.

5. The storage compartment of claim 1, wherein the electrical panel comprises a lightning port.

6. The storage compartment of claim 1, wherein the electronic panel is positioned inside the storage compartment.

7. The storage compartment of claim 1, wherein the electronic panel is positioned on the real wall of the storage compartment.

8. The storage compartment of claim 1, further comprising a horizontal utility shelf configured to be removably positionable by a user inside the storage compartment.

9. The storage compartment of claim 1, further comprising a horizontal hanging file hanger positioned inside the storage compartment and configured to secure a hanging file.

10. The storage compartment of claim 1, further comprising a removably mountable spacer positioned inside the storage compartment and configured to secure an item in the storage compartment.

11. The storage compartment of claim 7, wherein the spacer is sized and configured to secure a laptop computer.

12. The storage compartment of claim 1, further comprising a cord manager positioned inside the storage compartment and configured to secure an electrical cord.
